(19) United States
(12) Patent Application Publication
(10) Pub. No.: US 2003/0199284 A1
(43) Pub. Date: Oct. 23, 2003

(54) Mobile device power modulation for detecting imaging device proximity

(76) Inventors: Robert D. Christiansen, Boise, ID (US); Patrick O. Sandfort, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/126,703

(22) Filed: Apr. 19, 2002

(51) Int. Cl. H04B 7/00

(52) U.S. Cl. 455/522; 455/572; 455/574

(57) ABSTRACT

This invention relates to a method for detecting imaging device proximity. Such structures of this type, generally, detect the closest imaging device to the user by equipping the user's mobile device with a “slider” graphical user interface (GUI) element that represents the current power level for receiving wireless signals from imaging devices. If the power level setting is turned to its maximum value, then the wireless receiver or mobile device would maximize its power so that all imaging devices in the range would be detected. If that results in too many imaging devices for the user to select from, then the setting value can be decreased until a small enough (acceptable for that user) list of imaging devices is presented.

### FIELD OF THE INVENTION

This invention relates to a method for detecting imaging device proximity. Such structures of this type, generally, detect the closest imaging device to the user by equipping the user's mobile device with a “slider” graphical user interface (GUI) element that represents the current power level for receiving wireless signals from imaging devices. If the power level setting is turned to its maximum value, then the wireless receiver or mobile device would maximize its power so that all imaging devices in the range would be detected. If that results in too many imaging devices for the user to select from, then the setting value can be decreased until a small enough (acceptable for that user) list of imaging devices is presented.

### DESCRIPTION OF THE RELATED ART

With the advent of mobile devices, such as the personal digital assistant (PDA), a user is often located away from the user's default printing device. If the user needs to print a document from the user's mobile device, a problem is encountered, unless the user can locate a suitable printing device that is capable of printing the document. Therefore, an advantageous system, then, would be presented if the user could determine the proximity of the closest, suitable printing device.

Prior to the present invention, as set forth in general terms above and more specifically below, it is known, in the proximity detection art, to employ a variety of location methods to detect the location of one object with respect to another. Exemplary of such prior art are U.S. Pat. No. 5,995,046 ('046) to D. K. Belcher et al., entitled “Radio Geo-Location System with Advanced First Received Wavefront Arrival Determination,” U.S. Pat. No. 6,134,448 ('448) to Y. Shoji et al., entitled “System for Detecting Positional Information,” U.S. Pat. No. 6,222,482 ('482) to A. Gueziec, entitled “Hand-Held Device Providing a Closest Feature Location in a Three-Dimensional Geometry Database,” U.S. Pat. No. 6,259,405 ('405) to B. H. Stewart et al., entitled “Geographic Based Communications Service,” U.S. Pat. No. 6,292,106 ('106) to J. C. Solinsky et al., entitled “Acoustical System and Method for Simultaneously Locating and Tracking Multiple Personnel in Rooms of a Building,” and U.S. Pat. No. 6,327,535 ('535) to S. S. Evans et al., entitled “Location Beaconing Methods and Systems.” While the '046, '448, '482, '405, '106, and '535 references disclose a variety of location methods, they do not employ a power modulation of the mobile device to determine imaging device proximity. Therefore, a further advantageous system, then, would be presented if the location system employed power modulation of the mobile device to determine imaging device proximity.

It is also known, in the proximity detection art, to sense the proximity of the object using near-field effects. Exemplary of such prior art is U.S. Pat. No. 5,459,405 ('405) to G. D. Wolff et al., entitled “Method and Apparatus for Sensing Proximity of an Object Using Near-Field Effects.” While the '405 reference teaches the use of near-field effects to determine the proximity of one object with respect to another, again, there is no teaching, suggesting or even appreciation for employing power modulation of the mobile device to determine imaging device proximity. Therefore, a still further advantageous system, then, would be presented if the location system employed power modulation of the mobile device to determine imaging device proximity.

It is apparent from the above that there exists a need in the art for a imaging device location system which is capable of employing power modulation of the mobile device to determine imaging device proximity and which at least equals the locating characteristics of the known locating systems. It is a purpose of this invention to fulfill this and other needs in the art in a manner more apparent to the skilled artisan once given the following disclosure.

### SUMMARY OF THE INVENTION

Generally speaking, this invention fulfills these needs by providing a method for mobile device power modulation to detect imaging device proximity, wherein the method is comprised of the steps of: using a mobile device to interact with a network list of imaging devices; modulating the power of the mobile device to adjust the list; and determining a closest imaging device to the user.

In certain preferred embodiments, the mobile device can be, but is not limited to, a computer, a laptop computer, a personal digital assistant (PDA) or the like. The power of the mobile device can be modulated, for example, by operating a “slider” located on the graphical user interface (GUI) of the mobile device. The power modulation of the mobile device allows the user to limit the search of available imaging devices located within a specified network. The imaging device can be, but is not limited to, a printing device, a digital sender, a scanner or the like. The method also includes the step of downloading a unique identifier from the closest imaging device to the mobile device. The unique identifier can be, but is not limited to, a network address or the like.

In another further preferred embodiment, the imaging device physically available to the user can be found without having to decipher the sometimes cryptic definition of an imaging device presented by various operating systems.

The preferred proximity detection system, according to this invention, offers the following advantages: ease in detecting imaging device proximity; ease in determining the imaging device's unique identifier; ease of imaging; and excellent economy. In fact, in many of the preferred embodiments, these factors of ease in detecting imaging device proximity, ease in determining the imaging device's unique identifier, and ease of imaging are optimized to an extent that is considerably higher than heretofore achieved in prior, known imaging device proximity detection systems.

The above and other features of the present invention, which will become more apparent as the description proceeds, are best understood by considering the following detailed description in conjunction with accompanying drawing figures, wherein like characters represent like parts throughout the several views and in which:

### BRIEF DESCRIPTION OF THE DRAWINGS

FIG. 1 is a schematic illustration of a method for detecting an imaging device proximity using power modulation of the mobile device, according to one embodiment of the present invention;

FIG. 2 is a flowchart that illustrates the method for detecting imaging device proximity using power modulation of the mobile device, according to one embodiment of the present invention; and

FIG. 3 is a schematic illustration of a slider element on a mobile device, according to another embodiment of the present invention.

### DETAILED DESCRIPTION OF INVENTION

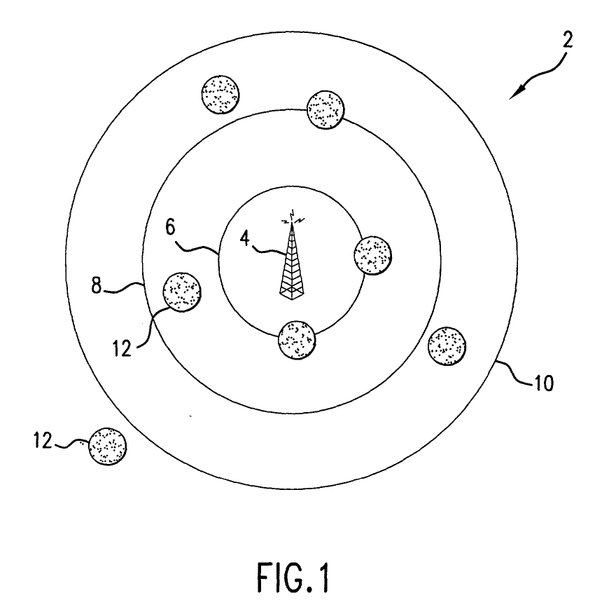

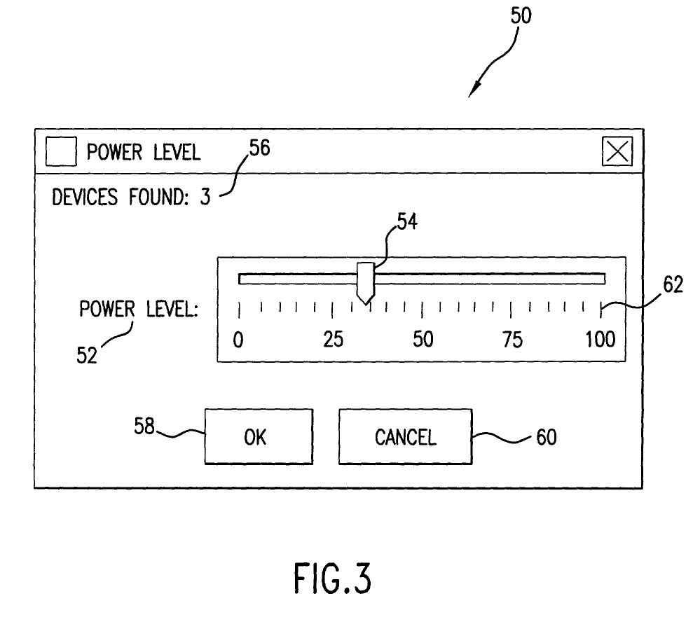

With reference to FIG. 1, there is illustrated one preferred embodiment for use of the concepts of this invention. System 2 for detecting an imaging device proximity is illustrated in FIG. 1. System 2 includes, in part, mobile device 4, reception ranges 6, 8, 10 and imaging devices 12. It is to be understood that mobile device 4 includes a display 50 on a graphical user interface (GUI) having a mechanism that is capable of modulating the reception power of the mobile device. For example, a “slider” 54 (FIG. 3) maybe located on display 50 of the GUI to assist in modulating the power of mobile device 4. It is also to be understood that mobile device 4 includes an antenna for receiving wireless communications from imaging devices 12. Finally, it is to be understood that imaging devices 12 are conventionally equipped so as to be able to wirelessly communicate with mobile device 4. For example, a Simple Network Management Protocol (SNMP) can be used during the interaction between the imaging device and the mobile device. SNMP is a widely used, common communications protocol that is found in almost all conventional imaging devices. SNMP allows the imaging devices or agents to provide information about themselves, such as what the imaging device can do and what can be controlled in the imaging device, in a common storage area or MIB. The information about a particular imaging device or agent can then be accessed by a user or requester, such as the user's mobile device 4.

With respect to reception ranges 6, 8 and 10, these are related to the amount of receiving power in the antenna of mobile device 4. If, for example, the receiving power in mobile device 4 were modulated to a low power, then only those imaging devices 12 within reception range 6 would be shown on the display 50 of mobile device 4. However, if the receiving power in mobile device 4 were modulated to a higher power, then those imaging devices 12 within reception ranges 6, 8 and 10 would be shown on the display 50 of mobile device 4 depending upon how high the receiving power was modulated. It is to be understood that reception ranges 6, 8, and 10 can be gauged in terms of distance. For example, reception range 6 can extend out five meters from mobile device 4, while reception ranges 8 and 10 can extend out 10 and 15 meters, respectfully. It is also to be understood that other distances can be used. Finally, as can be seen in FIG. 1, if imaging device 12 is located outside of reception ranges 6, 8 and 10, these imaging devices 12 would not be detected by mobile device 4 and, consequently, not listed on mobile device 4.

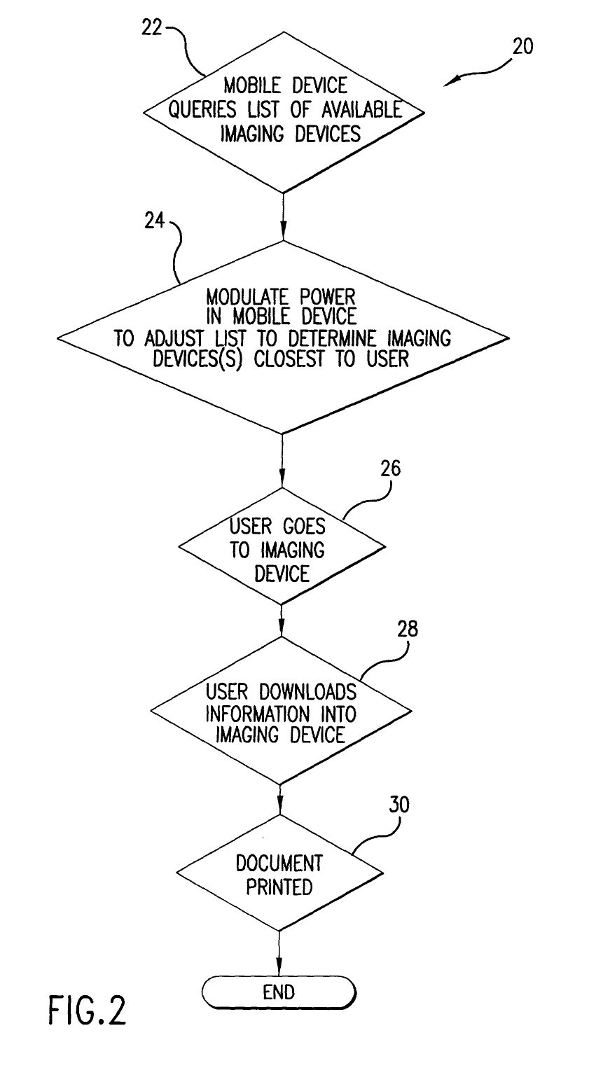

With respect to FIG. 2, there is illustrated method 20 for using mobile device power modulation to detect imaging device proximity. Method 20 includes, in part, the steps of using a mobile device 4 to interact with/query a network list of imaging devices 12 (step 22), modulating the power in the mobile device 4 to adjust the list to determine which imaging device (s) 12 are closest to the user (step 24), listing the location of the desired imaging device 12 on the mobile device 4 and having the user go to the desired imaging device 12 listed on the mobile device 4 (step 26), downloading, by the mobile device 4, the print job information to be printed by the desired imaging device 12 (step 28), and printing the information (step 30).

With respect to step 22, it is to be understood that the mobile device 4 can be, but is not limited to, a computer, a laptop computer, a personal digital assistant (PDA) or the like. Also, the term “network list” refers to a conventionally prepared list of network addresses of all the imaging devices 12 in the area defined by the network. For example, the network list may refer to a listing of all the printers in a local area network (LAN). Finally, it is to be understood that the imaging device 12 can be, but is not limited to, a printing device, a digital sender, a scanner or the like. With respect to steps 22-28, the (SNMP), as described above, is used during the interaction between the imaging device 12 and the mobile device 4.

With respect to step 24, as described above, the user views the list provided in step 22, above on mobile device 4. If, for example, there are too many imaging devices 12 provided in the initial list of step 22, the user can modulate the receiving power of mobile device 4 to reduce the reception from reception range 8 to reception range 6 (FIG. 1). This should reduce the number of imaging devices 12 listed on mobile device 4 to a manageable number from which the user can select the closest imaging device 12. Conversely, if the initial list provided in step 22, above, lists no available imaging devices 12 or just a few imaging devices 12, the receiving power of mobile device 4 can be modulated to increase the reception range of mobile device 4.

With respect to step 26, once the user has narrowed list of closest imaging devices 1 2, the network address of that imaging device(s) is (are) listed on the mobile device and the user can then, if necessary, proceed to that listed imaging device (s) 12.

With respect to step 28, once the user is located in front of listed imaging device 12, the imaging device 12 conventionally downloads a unique identifier to the user's mobile device 4. It is to be understood that the term “unique identifier” can be, but is not limited to, a network address or any such identifier that is unique to that particular imaging device. After the unique identifier has been downloaded to the user's mobile device 4, mobile device 4 will then be able to conventionally download the print job information on mobile device 4 to imaging device 12, as shown in step 28. Finally, the document is printed, as shown in step 30.

With respect to FIG. 3, display 50 is illustrated. Display 50 includes, in part, power level 52, slider 54, device counter 56, OK button 58, cancel button 60, and power scale 62. It is to be understood that display 50 can be located on a GUI of mobile device 4 (FIG. 1), as discussed above.

During the operation of mobile device 4, the user conventionally operates mobile device 4 in order to move slider 54 along power scale 62 in order to modulate power level 52. As the user moves slider 54, the number of imaging devices located within that particular power lever 52 is shown at device counter 56. Once the user is satisfied with the number of imaging devices in device counter 56, the user may merely conventionally “click” on OK button 58 or use any other suitable technique so that the network address(es) of the imaging device(s) listed on device counter 56 can be displayed to the user through the GUI on mobile device 4 (step 26 in FIG. 2). If the user is not satisfied with the number of imaging devices shown in device counter 56, the user may then merely “click” on cancel button 60 or use any other suitable technique to start the process over (step 24 in FIG. 2).

Once given the above disclosure, many other features, modifications or improvements will become apparent to the skilled artisan. Such features, modifications or improvements are, therefore, considered to be a part of this invention, the scope of which is to be determined by the following claims.

What is claimed is:

1. A method for mobile device power modulation to detect imaging device proximity, comprising the steps of:
using a mobile device to interact with a network list of imaging devices;
modulating the power of said mobile device to adjust said list; and
determining a closest imaging device to the user.

2. The method, as in claim 1, wherein said method is further comprised of the step of:
uploading, by said imaging device, of a unique identifier of said imaging device to said mobile device.

3. The method, as in claim 1, wherein said method is further comprised of the step of:
printing a document on said imaging device.

4. The method, as in claim 1, wherein said step of using said mobile device to interact with a network list of imaging devices is further comprised of the step of:
using said mobile device to query said network list.

5. The method, as in claim 1, wherein said step of using said mobile device to interact with a network list of imaging devices is further comprised of the step of:
utilizing a common communications protocol between said imaging device and said mobile device.

6. The method, as in claim 5, wherein said common communications protocol is further comprised of:
a Simple Network Management Protocol (SNMP).

7. The method, as in claim 1, wherein said modulating step is further comprised of:
modulating a receiving power of said mobile device in order to alter a reception range of said mobile device.

8. The method, as in claim 7,wherein said step of modulating a receiving power of said mobile device is further comprised of the step of:
operating a slider element located on a graphical user interface on said mobile device.

9. The method, as in claim 1, wherein said mobile device is further comprised of:
a laptop computer.

10. The method, as in claim 1, wherein said mobile device is further comprised of:
a personal digital assistant.

11. The method, as in claim 1,wherein said imaging device is further comprised of:
a printing device.

12. A program storage medium readable by a computer, tangibly embodying a program of instructions executable by said computer to perform method steps for mobile device power modulation to detect imaging device proximity, comprising the steps of:
using a mobile device to interact with a network list of imaging devices;
modulating the power of said mobile device to adjust said list; and determining a closest imaging device to the user.

13. The method, as in claim 12, wherein said method is further comprised of the step of:
uploading, by said imaging device, of a unique identifier of said imaging device to said mobile device.

14. The method, as in claim 12, wherein said method is further comprised of the step of:
printing a document on said imaging device.

15. The method, as in claim 12, wherein said step of using said mobile device to interact with a network list of imaging devices is further comprised of the step of:
using said mobile device to query said network list.

16. The method, as in claim 12, wherein said step of using said mobile device to interact with a network list of imaging devices is further comprised of the step of:
utilizing a common communications protocol between said imaging device and said mobile device.

17. The method, as in claim 16, wherein said common communications protocol is further comprised of:
a Simple Network Management Protocol (SNMP).

18. The method, as in claim 1 2, wherein said modulating step is further comprised of:
modulating a receiving power of said mobile device in order to alter a reception range of said mobile device.

19. The method, as in claim 18, wherein said step of modulating a receiving power of said mobile device is further comprised of the step of:
operating a slider element located on a graphical user interface on said mobile device.
